(19) United States
(12) Patent Application Publication
(10) Pub. No.: US 2008/0239621 A1
(43) Pub. Date: Oct. 2, 2008

(54) Clip-on leadframe

(76) Inventors: Azizuddin Tajuddin, Laurens, SC (US); Michael S. Randall, Simpsonville, SC (US); Roy Grace, Simpsonville, SC (US); Mark R. Laps, Simpsonville, SC (US)

Correspondence Address: NEXSEN PRUET, LLC, P.O. BOX 10648, GREENVILLE, SC, 29603, US

(21) Appl. No.: 11/729,688

(22) Filed: Mar. 29, 2007

(51) Int. Cl. H01G 4/228; B23P 19/00

(52) U.S. Cl. 361/306.1; 29/739

(57) ABSTRACT

A capacitor with a multiplicity of first plates and second plates in parallel relationship wherein the first plates terminate at a first face and the second plates terminate at a second face. A dielectric is between the first plates and the second plates. A first external termination is in electrical contact with the first plates and a second external termination is in electrical contact with the second plates. A first lead terminal is in electrical contact with the first external termination and the first lead terminal has a first foot below the first external termination and a first solder stop coated on the first foot between the first foot and the first external termination. A second lead terminal is in electrical contact with the second external termination wherein the second lead terminal comprises a second foot below the second external termination and a second solder stop is coated on the second foot between the second foot and the second external termination.

### FIELD OF THE INVENTION

The present invention is related to an improved lead frame for ceramic chip capacitors. More specifically, the present invention is related to ceramic capacitors comprising lead frame structures and attachment methods therefore to minimize solder wicking into electrical contact with the external electrodes of the capacitor.

### BACKGROUND OF THE INVENTION

Capacitors, particularly interdigitated capacitors, are well known in the art of electrical components. Capacitors typically comprise parallel plates, which act as anodes and cathodes, with a dielectric there between. The function of capacitors is well known and further discussion is not warranted herein.

Capacitors are typically secured to a substrate as a component to a printed circuit board (PCB) by soldering. The propensity for solder to wick on the lead frame has been an ongoing problem leading to a myriad of unsatisfactory solutions.

One widely known method for preventing solder from wicking is to utilize lead frames, as illustrated in FIG. 1, which elevates and isolates the capacitor above the substrate. The solder, 403, can wick onto the top surface of the lead frame between the lead frame and capacitor without detriment. This method has been widely used in the past yet the length of the lead frame is antithetical to ongoing efforts to reduce inductance and resistance thereby rendering this method inappropriate for modern circuits with increased demands for lower inductance and resistance. Until recently, reducing the separation between the capacitor and substrate has been considered impossible due to problems associated with solder flowing upward and causing elimination of the mechanical independence of the leadframe system.

Yet another method for eliminating solder wicking is to coat the lower portion of the capacitor as illustrated in FIG. 2 and detailed in U.S. Pat. No. 6,903,920. This method, though effective, increases the manufacturing cost and has residual parasitics thereby limiting widespread applicability.

There remains a need for a novel capacitor presentation, which greatly decreases the propensity for solder migration, or wicking, by utilizing a unique leadframe attachment and mounting method. Such a novel capacitor, and mounting method, can achieve the elimination of direct contact with solder and the external electrode of the capacitor while still maintaining the desired ceramic capacitor performance and especially the higher capacitance capabilities in larger chips.

### SUMMARY OF THE INVENTION

It is an object of the present invention to provide a capacitor that is less susceptible to solder wicking, or migration, and which solves the problems posed by the leadframe attachment method of the aforementioned prior art.

It is another object of the present invention to provide a capacitor wherein the lead frame has minimized resistive, inductive and thermal parasitics.

A particular feature of the present invention is the ability to utilize a low profile lead frame while avoiding the problems associated with solder wicking.

Yet another feature of the present invention is minimized parasitics relative to the relevant prior art.

These and other embodiments are provided in a capacitor. The capacitor has a multiplicity of first plates and second plates in parallel relationship wherein the first plates terminate at a first face and the second plates terminate at a second face. A dielectric is between the first plates and the second plates. A first external termination is in electrical contact with the first plates and a second external termination is in electrical contact with the second plates. A first lead terminal is in electrical contact with the first external termination wherein the first lead terminal comprises a first solder stop. A second lead terminal is in electrical contact with the second external termination wherein the second lead terminal comprises a second solder stop.

Yet another embodiment is provided in a capacitor. The capacitor has a multiplicity of first plates and second plates in parallel relationship wherein the first plates terminate at a first face and the second plates terminate at a second face. A dielectric is between the first plates and the second plates. A first external termination is in electrical contact with the first plates and a second external termination is in electrical contact with the second plates. A first lead terminal is in electrical contact with the first external termination and the first lead terminal has a first foot below the first external termination and a first solder stop coated on the first foot between the first foot and the first external termination. A second lead terminal is in electrical contact with the second external termination wherein the second lead terminal comprises a second foot below the second external termination and a second solder stop is coated on the second foot between the second foot and the second external termination.

Yet another embodiment is provided in a capacitor. The capacitor has a multiplicity of first plates and second plates in parallel relationship wherein the first plates terminate at a first face and the second plates terminate at a second face. A dielectric is between the first plates and the second plates. A first external termination is in electrical contact with the first plates and a second external termination is in electrical contact with the second plates. A first lead terminal is in electrical contact with the first external termination and the first lead terminal comprises a first foot with an interior edge on the first foot wherein the interior edge comprises a first surface material which is not wet by molten solder. A second lead terminal is in electrical contact with the second external termination and the second lead terminal comprises a second foot with a second interior edge on the second foot wherein the second interior edge comprises a second surface material which is not wet by molten solder.

Yet another embodiment is provided in a capacitor. The capacitor has a multiplicity of first plates and second plates in parallel relationship wherein the first plates terminate at a first face and the second plates terminate at a second face. A dielectric is between the first plates and the second plates. A first external termination is in electrical contact with the first plates and a second external termination is in electrical contact with the second plates. A first lead terminal is in electrical contact with the first external termination wherein the first lead terminal comprises a first foot comprising a first solder pad on the first foot opposite to the first lead terminal. A second lead terminal is in electrical contact with the second external termination wherein the second lead terminal comprises a second foot comprising a second solder pad on the second foot opposite to the first lead terminal.

Yet another embodiment is provided in a process for mounting a capacitor. The process includes the steps of:

providing a capacitor wherein the capacitor has a multiplicity of first plates and second plates in parallel relationship wherein the first plates terminate at a first face and said second plates terminate at a second face; a dielectric between the first plates and second plates; a first external termination in electrical contact with the first plates and a second external termination in electrical contact with said second plates; a first lead terminal in electrical contact with the first external termination wherein the first lead terminal comprises a first foot with a first solder pad on the first foot opposite to the first external termination; and a second lead terminal in electrical contact with the second external termination wherein the second lead terminal comprises a second foot with a second solder pad on the foot opposite to the second external termination;
providing a printed circuit board with circuit traces;
placing the capacitor on the circuit board with the first solder pad in contact with a first circuit trace of the circuit traces and the second solder pad in contact with a second circuit trace of the circuit traces; and
flowing the solder to form a bond between the lead frame and said trace.

Yet another embodiment is provided in a process for mounting a capacitor. The process includes the steps of:

providing a capacitor with a multiplicity of first plates and second plates in parallel relationship wherein the first plates terminate at a first face and the second plates terminate at a second face; a dielectric between the first plates and second plates; a first external termination in electrical contact with the first plates and a second external termination in electrical contact with the second plates; a first lead terminal in electrical contact with the first external termination wherein the first lead terminal comprises a first foot; and a second lead terminal in electrical contact with the second external termination wherein the second lead terminal comprises a second foot;
providing a printed circuit board with circuit traces with solder pads on the circuit traces;
placing the capacitor on the circuit board with the first foot in contact with a first solder pad and the second foot in contact with a second solder pad; and
flowing the solder to form a bond between the lead frame and the trace.

### BRIEF DESCRIPTION OF THE DRAWINGS

FIG. 1 is cross-sectional schematic view of a prior art ceramic capacitor chip with elevated lead frames attached and mounted to a printed circuit board (PCB).

FIG. 2 is a cross-sectional schematic view of a prior art ceramic capacitor with a low profile leadframe attached and mounted to a PCB.

FIG. 3 is a cross-sectional schematic view of a capacitor chip.

FIG. 4 is a cross-sectional schematic view of an embodiment of the present invention.

FIG. 5 is a schematic side view of an embodiment of the present invention.

FIG. 6 is a schematic side view of an embodiment of the present invention.

FIG. 7 is a schematic partial cut-away side view of an embodiment of the present invention.

### DETAILED DESCRIPTION OF THE DRAWINGS AND INVENTION

The invention will be described with reference to the drawings which form an integral part of the disclosure. In the various drawings, similar elements will be numbered accordingly.

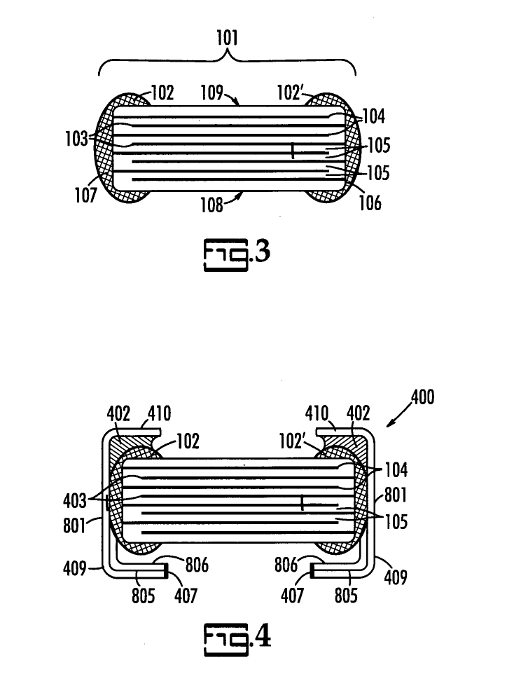

The configuration of ceramic multilayer capacitors is well known in the art. FIG. 3 is a cross-sectional view of an exemplary structure of a multilayer ceramic capacitor chip, 101. The shape of the capacitor chip, 101, is not critical although it is often rectangular shaped. Also, the size is not critical and the chip may have appropriate dimensions in accordance with a particular application, typically in the range of 1.0 to 10 mm in length by 0.5 to 10 mm in width and 0.5 to 2.0 mm in height.

In FIG. 3, the capacitor chip, 101, has a plurality of alternately stacked internal electrode layers, also known as plates, 103 and 104. In FIG. 3, the capacitor chip, 101, is non-polar because the plates are oppositely charged, positive and negative, but can be charged in either direction. Dielectric layers, 105, separate the internal electrode layers, 103 and 104. Further, the internal electrode layers, 103 and 104, are stacked so that internal electrode layers, 103, of one group are exposed at one side surface, 106, of the capacitor chip, 101, while internal electrode layers, 104, of another group are exposed at the opposite side surface, 107, of the capacitor chip, 101. The capacitor chip, 101, also has external electrodes, also known as terminations, 102 and 102′. One external electrode, 102, is applied to one side surface, 107, of the capacitor chip, 101, so that it is in electrical contact with one group of internal electrode layers, 104, of the capacitor chip, 101. Likewise, the other external electrode, 102′, is applied to the opposite side surface, 106, of the capacitor chip, 101, so that it is in electrical contact with the other group of internal electrode layers, 103, of the capacitor chip, 101. The plate arrangement is usually with adjacent internal electrode layers, 103 and 104, terminating to opposite face terminations, 102 and 102′, and non-adjacent internal electrode layers, 103 and 104, terminating to the same side surface, 106 or 107, respectively. Further, the internal electrode layers or plates, 103 and 104, are offset in such a manner that they extend to the side surfaces, 106 and 107, of the capacitor chip, 101, but only at the external electrodes or terminations, 102 and 102′; otherwise, they are encased and insulated from all other faces by ceramic material. A top face, 109, and bottom face, 108, of the capacitor chip, 101, are designated here by convention, but in reality, these orientations are defined when the chip is mounted to the PCB. The terminations, 102 and 102′, wrap onto the bottom face, 108, which is in closest contact to solder pads on the PCB. A desired capacitor circuit is completed in this way.

While described herein with reference to alternating plate capacitors other configurations can be used such as floating plate capacitors wherein the terminating plates are coplanar with parallel non-terminating plates alternating therewith.

The terminations, 102 and 102′, are typically metalizations and are applied to the ceramic of the capacitor chip, 101, using a termination dip. The terminations, 102 and 102′, may be applied as metallic particles suspended in slurry with a glass frit. The terminations, 102 and 102′, are fired on the side surfaces, 106 and 107, of the ceramic capacitor chip, 101, with the glass frit acting as a bonding agent between the metal particles and the ceramic body.

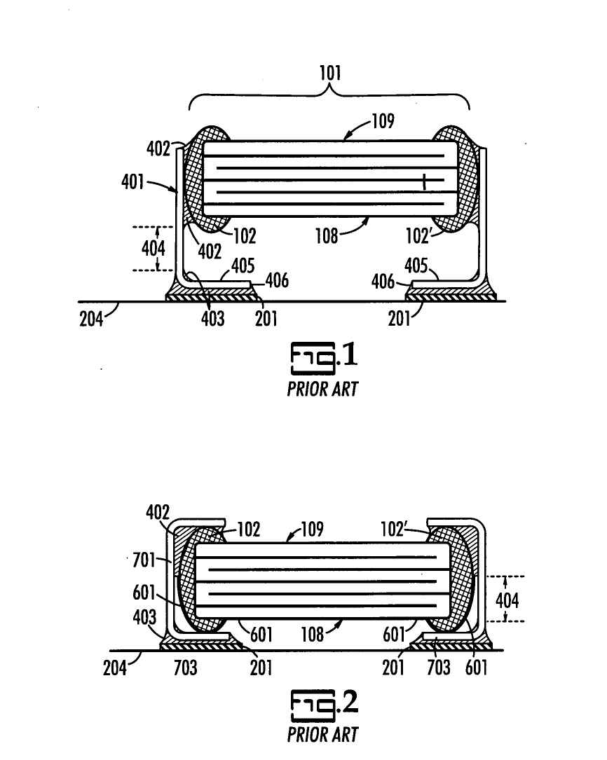

FIG. 1 illustrates a cross-sectional view of a ceramic capacitor chip, 101, mounted to pads, 201, on a PCB, 204, using an elevated leadframe, 401. The leadframe, 401, is typically a copper, copper alloy, or nickel based material that is often plated with nickel (except when the leadframe is a nickel based material), tin, solder, or gold. The ceramic chip, 101, is typically first attached to the lead frame terminals, 401, using a solder, 402, or conductive adhesive. The leadframe, 401, is then soldered, 403, to the circuit traces, 201, on the PCB, 204. If solder is used in attaching the leadframe, 401, to the capacitor chip, 101, the solder, 402, is usually a high temperature solder, such as 95% Sn-5% Pb MP 224° C. solder; 96.5% Sn-3.5% Ag MP 221° C. solder or a conductive resin. A high temperature solder, 402, assures that the leadframe, 401, remains attached to the capacitor chip, 101, during the reflow temperatures encountered when the leadframe, 401, is attached to the trace, 201, of the PCB surface, 204. Those in the art will recognize that alternative solders for attaching the lead frame to the capacitor chip could be used to eliminate the use of lead-based solder. During the soldering of the lead frame the molten solder wicks onto the edge, 406, and top surface, 405, of the lead frame. The free vertical length, 404, of the leadframe, 401, separates the ceramic capacitor, 101, from the top surface of the lead frame to avoid contact with the solder. If the solder, 403, were allowed to wick up the leadframe, 701, and establish a bridged contact to the lower portions of the end terminations, 102 and 102′, electrical properties of the connection are compromised. In order to assure that this bridging cannot occur, the extension of the leadframe above the PCB, 204, must be large enough to eliminate this possibility.

A second prior art approach is illustrated in FIG. 2 and further described in commonly assigned U.S. Pat. No. 6,903,920 which is incorporated by reference. In FIG. 2 a cross-sectional view of the ceramic chip capacitor is pretreated with an insulative coating, 601, assembled to a leadframe, 701, and mounted to the circuit trace, 201, of a PCB, 204. The leadframe, 701, has no additional extension of the vertical member of the leadframe, however, there is a separation distance, 404, of the leadframe, 701. The foot, 703, of the leadframe is bent under the capacitor chip and may be in physical contact with the coating, 601, on the lower extremes, 702, of the end terminations, 102 and 102′, of the capacitor chip. Because this coating is insulative, the solder connection, 403, to the pads, 201, on the PCB, 204, has no chance of forming a mechanical bridge directly from the pads, 201, to the lower extremes, 702, of the termination ends, 102, and 102′. The increase in height for the capacitor chip, 101, from the PCB, 204, is only the thickness of the foot of the leadframe, 401, plus the coating, 601. The reduction in height of the leadframe, 401, reduces resistive, inductive, and thermal parasitics relative to the lead frame illustrated in FIG. 1 yet there is still some resistive, inductive and thermal parasitics due to the separation distance, 404. This approach, though effective, increases manufacturing cost of the capacitor and still does not completely defeat parasitics.

A cross-sectional view of an embodiment of the present invention is illustrated in FIG. 4. In FIG. 4, the capacitive element, generally represented at 400, comprises a capacitor with a lead frame attached thereto the details of which will be described further. The capacitor comprises alternately stacked internal electrode layers, 103 and 104, which terminate at external electrodes, 102, of opposing polarity. A dielectric, 105, is between the internal electrode layers. A pair of lead frames, 401, each comprising a foot, 405, forms electrical contact with the external electrodes and provides a mounting surface for attachment of the capacitive element to a printed circuit board or the like. A solder stop on the lead frame prohibits solder from wetting the surface or otherwise migrating into electrical contact with the external termination. An interior edge, 407, of the foot, comprises a solder stop which is not wet by molten solder. The inability of solder to wet the interior edge prohibits to a certain degree the ability of the solder to wick onto the upper surface of the foot between the foot and the capacitor. On the interior of the lead frame is a solder stop layer, 806, which is not wet by molten solder. The solder stop layer is preferably applied to at least one of the upper surface of the foot and a portion of the riser, 409, of the lead frame. It is most preferable that the solder stop layer not extend up the riser more than 80% the thickness of the capacitor to insure adequate surface area for a conductive adhesive, 402, between the lead frame and external termination. Minimizing the length of solder stop layer on the riser also minimizes resistive, inductive and thermal parasitics. The lead frame may comprise a roof portion, 410, to provide additional surface area for adhesive.

By providing a surface on the upper surface of the foot which is not wet by molten solder the necessity for a separating distance between the capacitor and foot is negated. This allows for the use of a low profile lead frame without the problems associated with solder wicking on the upper side of the foot as widely realized in the art and eliminates the necessity of an insulative coating on the capacitor chip. The solder stop can be applied to the lead frame prior to commencement of the capacitor formation process which enhances manufacturing efficiency.

The solder stop layer is a material capable of being coated onto the lead frame and which is not wet by molten solder. Particularly preferred materials include metal oxides, organics, preferably polymeric materials and solder mask. In a particularly preferred embodiment the solder stop layer is an accelerated oxide of the lead frame metal which is more highly oxidized than native oxide formed under ambient conditions. More preferred materials include nitrides, oxides, ceramics, shellacs, glasses, epoxies, varnishes, polyamides, polyimides and the like.

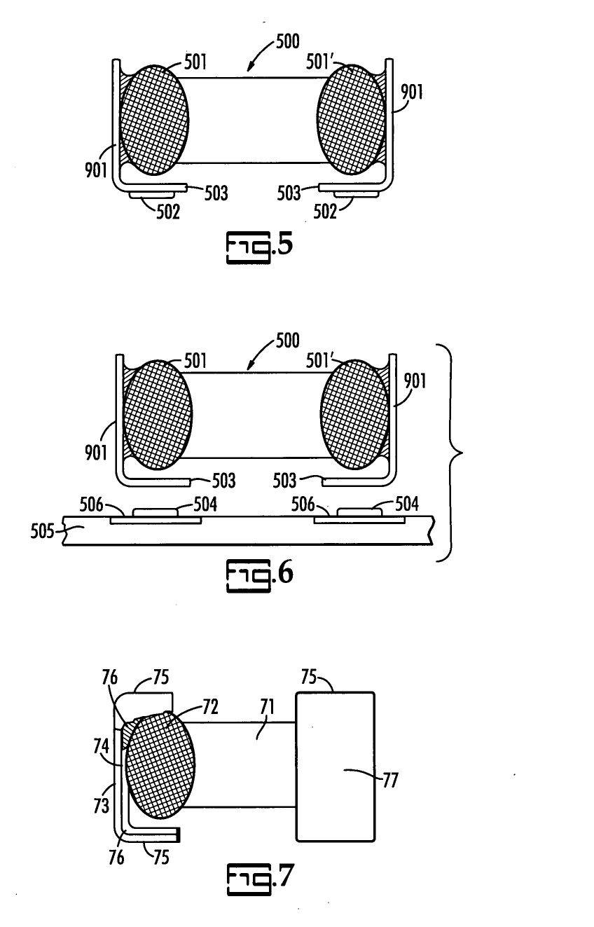

Another embodiment of the invention is illustrated schematically in FIG. 5. In FIG. 5, the capacitor, 500, comprises external terminations, 501. A lead frame, 901, is in electrical contact with each external termination. The foot, 503, of each external termination has a pre-deposited solder pad, 502. During mounting of the capacitor to a circuit trace the capacitor is placed in the proper location and the solder is free-flowed. The volume of solder in the pre-deposited solder pad is sufficient to bond the foot of the lead frame to the circuit trace but not a sufficient amount to wick up the interior edge, side edge or onto the top of the foot.

Another embodiment of the present invention is illustrated in exploded schematic view in FIG. 6. In FIG. 6, the capacitor, 500, external terminations, 501, lead frame, 901 and foot, 503, are as described with reference to FIG. 5. A circuit board substrate, 505, comprising traces, 506, is illustrated. As would be realized the foot of the lead frame is secured to the trace as standard in the art. In the embodiment of FIG. 6 a solder pad, 504, is pre-deposited on the trace, 506. The pre-deposited solder pad allows the capacitor to be placed followed by reflowing the solder to form a secure bond between the capacitor foot and the trace. The volume of pre-deposited solder is sufficient to bond the lead frame to the trace but not sufficient to wick onto the interior edge, side edge or top of the foot. The solder can be deposited by any technique known in the art.

Another embodiment is illustrated schematically in partial cut-away side view in FIG. 7. In FIG. 7 the capacitive body, 71, has external terminations, 72. A lead frame, 73, is electrically connected to each external termination at 74. Each lead frame comprises a solder stop, 76, as described herein. The embodiment of FIG. 7 is particularly advantageous since it can be mounted without regard for the top and bottom. The orientation of the internal electrodes relative to the foot is not particularly limited herein and they could be parallel, perpendicular or an angle in between. The lead frame has a top, 75, and side, 77, which may be indistinguishable thereby eliminating the necessity of properly rotationally orienting the capacitor prior to soldering.

The invention has been described with particular emphasis on the preferred embodiments without limit thereto. One of skill in the art would readily realize additional embodiments which are within the meets and bounds of the invention as more specifically set forth in the claims appended hereto.

What is claimed is:

1. A capacitor comprising:
a multiplicity of first plates and second plates in parallel relationship wherein said first plates terminate at a first face and said second plates terminate at a second face;
a dielectric between said first plates and said second plates;
a first external termination in electrical contact with said first plates and a second external termination in electrical contact with said second plates;
a first lead terminal in electrical contact with said first external termination wherein said first lead terminal comprises a first solder stop; and
a second lead terminal in electrical contact with said second external termination wherein said second lead terminal comprises a second solder stop.

2. The capacitor of claim 1 wherein said first lead terminal comprises a first foot below said first external termination and a first solder stop on said first foot between said first foot and said first external termination.

3. The capacitor of claim 2 wherein said first solder stop is in contact with said first external termination and said first foot.

4. The capacitor of claim 1 wherein said first solder stop is on a portion of a riser of said first lead frame.

5. The capacitor of claim 4 wherein said first solder stop covers less than one 80% of said riser.

6. The capacitor of claim 1 wherein said first solder stop is selected from a ceramic, an organic ceramic and organic material.

7. The capacitor of claim 1 wherein said solder stop is not wet by molten solder.

8. A printed circuit board comprising a capacitor of claim 1.

9. A capacitor comprising:
a multiplicity of first plates and second plates in parallel relationship wherein said first plates terminate at a first face and said second plates terminate at a second face;
a dielectric between said first plates and said second plates;
a first external termination in electrical contact with said first plates and a second external termination in electrical contact with said second plates;
a first lead terminal in electrical contact with said first external termination wherein said first lead terminal comprises a first foot with an interior edge on said first foot wherein said interior edge comprises a first surface material which is not wet by molten solder; and
a second lead terminal in electrical contact with said second external termination wherein said second lead terminal comprises a second foot with a second interior edge on said second foot wherein said second interior edge comprises a second surface material which is not wet by molten solder.

10. The capacitor of claim 9 wherein said first surface material comprises an oxide.

11. The capacitor of claim 9 further comprising a solder stop on said first foot.

12. The capacitor of claim 9 further comprising said solder stop on a riser of said first lead termination.

13. The capacitor of claim 12 wherein said solder stop covers less 80% of said riser.

14. The capacitor of claim 9 wherein said first solder stop is selected from a ceramic, an organic ceramic and an organic material.

15. The capacitor of claim 97 wherein said solder stop is not wet by molten solder.

16. A printed circuit board comprising the capacitor of claim 9.

17. A capacitor comprising:
a multiplicity of first plates and second plates in parallel relationship wherein said first plates terminate at a first face and said second plates terminate at a second face;
a dielectric between said first plates and said second plates;
a first external termination in electrical contact with said first plates and a second external termination in electrical contact with said second plates;
a first lead terminal in electrical contact with said first external termination wherein said first lead terminal comprises a first foot comprising a first solder pad on said first foot opposite to said first lead terminal; and
a second lead terminal in electrical contact with said second external termination wherein said second lead terminal comprises a second foot comprising a second solder pad on said second foot opposite to said first lead terminal.

18. The capacitor of claim 17 wherein said first foot comprises an interior edge which is not wet by molten solder.

19. The capacitor of claim 18 wherein said interior edge comprises an oxide.

20. The capacitor of claim 17 further comprising a solder stop on said first foot.

21. The capacitor of claim 17 further comprising a solder stop on a riser of said first lead termination.

22. The capacitor of claim 21 wherein said solder stop covers less than 80% of said riser.

23. The capacitor of claim 17 wherein said first solder stop is selected from a ceramic, an organic ceramic and an organic material.

24. The capacitor of claim 17 wherein said solder stop is not wet by molten solder.

25. A printed circuit board comprising the capacitor of claim 17.

26. A process for mounting a capacitor comprising:
providing a capacitor comprising:
a multiplicity of first plates and second plates in parallel relationship wherein said first plates terminate at a first face and said second plates terminate at a second face;
a dielectric between said first plates and said second plates;
a first external termination in electrical contact with said first plates and a second external termination in electrical contact with said second plates;
a first lead terminal in electrical contact with said first external termination wherein said first lead terminal comprises a first foot with a first solder pad on said first foot opposite to said first external termination; and
a second lead terminal in electrical contact with said second external termination wherein said second lead terminal comprises a second foot with a second solder pad on said foot opposite to said second external termination;
providing a printed circuit board comprising circuit traces;
placing said capacitor on said circuit board with said first solder pad in contact with a first circuit trace of said circuit traces and said second solder pad in contact with a second circuit trace of said circuit traces; and
flowing said solder to form a bond between said lead frame and said trace.

27. The process for mounting a capacitor of claim 26 wherein said first foot comprises an interior edge wherein said interior edge comprises a surface which is not wet by molten solder.

28. The process for mounting a capacitor of claim 27 wherein said surface is a metal oxide.

29. The process for mounting a capacitor of claim 26 wherein said first foot further comprises a solder stop between said first foot and said first external termination.

30. The process for mounting a capacitor of claim 29 wherein said first solder stop is selected from a ceramic, an organic ceramic and organic material.

31. The process for mounting a capacitor of claim 29 wherein said solder stop is not wet by molten solder.

32. The process for mounting a capacitor of claim 26 further comprising a solder stop on a riser of said first lead frame.

33. A process for mounting a capacitor comprising:
providing a capacitor comprising:
a multiplicity of first plates and second plates in parallel relationship wherein said first plates terminate at a first face and said second plates terminate at a second face;
a dielectric between said first plates and said second plates;
a first external termination in electrical contact with said first plates and a second external termination in electrical contact with said second plates;
a first lead terminal in electrical contact with said first external termination wherein said first lead terminal comprises a first foot; and
a second lead terminal in electrical contact with said second external termination wherein said second lead terminal comprises a second foot;
providing a printed circuit board comprising circuit traces with solder pads on said circuit traces;
placing said capacitor on said circuit board with said first foot in contact with a first solder pad and said second foot in contact with a second solder pad; and
flowing said solder to form a bond between said lead frame and said trace.

34. The process for mounting a capacitor of claim 33 wherein said first foot comprises an interior edge wherein said interior edge comprises a surface which is not wet by molten solder.

35. The process for mounting a capacitor of claim 34 wherein said surface is a metal oxide.

36. The process for mounting a capacitor of claim 33 wherein said first foot further comprises a solder stop between said first foot and said first external termination.

37. The process for mounting a capacitor of claim 36 wherein said first solder stop is selected from a ceramic, an organic ceramic and an organic material.

38. The process for mounting a capacitor of claim 36 wherein said solder stop is not wet by molten solder.

39. The process for mounting a capacitor of claim 33 further comprising a solder stop on a riser of said first lead frame.
